(19) United States
(12) Patent Application Publication
(10) Pub. No.: US 2025/0279551 A1
(43) Pub. Date: Sep. 4, 2025

(54) BATTERY MANUFACTURING APPARATUS AND BATTERY MANUFACTURING METHOD OF THE SAME

(71) Applicant: SK On Co., Ltd., Seoul (KR)

(72) Inventors: Yong Hun JUNG, Daejeon (KR); Wook Hyun KIM, Daejeon (KR)

(21) Appl. No.: 19/069,220

(22) Filed: Mar. 4, 2025

(30) Foreign Application Priority Data
Mar. 4, 2024 (KR) 10-2024-0030762

(51) Int. Cl. H01M 50/516; H01M 50/505

(52) U.S. Cl. CPC H01M 50/516; H01M 50/505

(57) ABSTRACT

A battery manufacturing apparatus for manufacturing a battery assembly including a plurality of battery cells, each having a lead tab portion electrically connected to an outside and protruding outwardly, and a busbar electrically connecting one or more battery cells among the plurality of battery cells of the present disclosure includes a welding wire, at least a portion of which is melted to weld the lead tab portion and the busbar, a supply portion supplying the welding wire to the lead tab portion, a guiding portion contacting the welding wire discharged from the supply portion and moving the welding wire in a direction in which the lead tab portion extends, and a laser irradiation portion irradiating the lead tab portion, the busbar, or the welding wire with a laser.

### CROSS-REFERENCE TO RELATED PATENT APPLICATION

The present application claims priority under 35 U.S.C. § 119 (a) to Korean patent application number 10-2024-0030762 filed on Mar. 4, 2024, in the Korean Intellectual Property Office, the entire disclosure of which is incorporated by reference herein.

### BACKGROUND OF THE INVENTION

### 1. Field

The present disclosure relates to a battery manufacturing apparatus and a battery manufacturing method using the battery manufacturing apparatus.

### 2. Description of the Related Art

A secondary battery converts electrical energy into chemical energy and stores the chemical energy, and can be reused multiple times by charging and discharging. Secondary batteries are widely used in various industries due to their economical and eco-friendly characteristics. In particular, lithium secondary batteries are widely utilized across industries, including mobile devices which require high-density energy.

The operating principle of a lithium secondary battery is an electrochemical oxidation-reduction reaction. In other words, electricity is generated by the movement of lithium ions and charged through the opposite process. In the case of a lithium secondary battery, the phenomenon of lithium ions escaping from an anode and moving to a cathode through an electrolyte and a separator is referred to as discharging. The opposite process of the phenomenon is referred to as charging.

To increase the capacity and output of secondary batteries, the secondary batteries may be bundled together. A busbar may be used to electrically connect the respective secondary batteries. When the secondary battery is welded to the busbar, the welding performance varies depending on a status of the secondary battery or the busbar, which affects the performance of the secondary battery. Therefore, research is being actively conducted to improve the welding performance of the secondary battery and the busbar.

### SUMMARY OF THE INVENTION

An object of the present disclosure is to weld a battery cell and a busbar quickly and reliably.

Another object of the present disclosure is to performing welding reliably regardless of a length of a lead tab portion.

In addition, the present disclosure can be widely applied in the field of electric vehicles, battery charging stations, and green technology, such solar power generation, and wind power generation using batteries.

The present disclosure can be used in eco-friendly electric vehicles, hybrid vehicles, etc. to prevent climate change by suppressing air pollution and greenhouse gas emissions.

A battery manufacturing apparatus for manufacturing a battery assembly including a plurality of battery cells, each having a lead tab portion electrically connected to an outside and protruding outwardly, and a busbar electrically connecting one or more battery cells among the plurality of battery cells according to embodiments of the present disclosure includes a welding wire, at least a portion of which is melted to weld the lead tab portion and the busbar, a supply portion supplying the welding wire to the lead tab portion, a guiding portion contacting the welding wire discharged from the supply portion and moving the welding wire in a direction in which the lead tab portion extends, and a laser irradiation portion irradiating the lead tab portion, the busbar, or the welding wire with a laser.

The supply portion may include a winder around which the welding wire is wound on an outer side thereof, and a roller unidirectionally transferring the welding wire unwound from the winder by rotation with the welding wire interposed therebetween.

The winder may be rotatably provided.

The guiding portion further may include a fixing portion formed by recessing one surface thereof.

The fixing portion may be removable from the welding wire.

The fixing portion may be movable in the direction in which the lead tab portion extends.

The battery manufacturing apparatus may further include a cutting portion cutting the welding wire moved in the direction in which the lead tab portion extends.

The cutting portion may be located on the guiding portion.

The cutting portion may be a knife.

The battery manufacturing apparatus may further include a blocking portion positioned between the laser irradiation portion and the plurality of battery cells and covering one or more battery cells among the plurality of battery cells.

The blocking portion may be formed by penetrating a region corresponding to the lead tab portion.

The supply portion may be movable in a direction in which the plurality of battery cells are stacked.

A battery manufacturing method of manufacturing a battery assembly including a plurality of battery cells, each having a lead tab portion electrically connected to an outside and protruding from one side thereof, and a busbar electrically connecting one or more battery cells among the plurality of battery cells battery manufacturing method includes inserting the lead tab portion into the busbar, supplying the welding wire toward the lead tab portion from the supply portion supplying the welding wire welding the lead tap portion and the busbar by melting at least a portion of the welding wire, and irradiating the lead tab portion, the busbar, or the welding wire with a laser.

In the supplying of the welding wire, the welding wire may move in a direction in which the lead tab portion extends.

The battery manufacturing method may further include moving the supply portion in a direction in which the plurality of battery cells are stacked.

The battery manufacturing method may further include arranging a blocking portion covering one or more battery cells among the plurality of battery cells on one side of the plurality of battery cells in a protruding direction of the lead tab portion.

The irradiating the laser may include irradiating the laser in a direction in which the lead tab portion extends.

The battery manufacturing method may further include cutting the welding wire moved in a direction in which the lead tab portion extends.

### BRIEF DESCRIPTION OF THE DRAWINGS

FIG. 1 shows a battery cell according to one embodiment of the present disclosure.

FIG. 2 shows a battery assembly according to one embodiment of the present disclosure.

FIG. 3 is an example block diagram related to control of a battery manufacturing apparatus according to one embodiment of the present disclosure.

FIGS. 4 to 7 show a welding process of a battery manufacturing apparatus according to one embodiment of the present disclosure.

FIGS. 8 and 9 show a supply portion according to one embodiment of the present disclosure.

FIGS. 10 and 11 show a blocking portion according to one embodiment of the present disclosure.

FIG. 12 is a flowchart illustrating a battery manufacturing method according to one embodiment of the present disclosure.

### DETAILED DESCRIPTION

Hereinafter, the present disclosure will be described in detail with reference to the attached drawings. This is merely illustrative, and the present disclosure is not limited to the specific embodiments described in an illustrative manner.

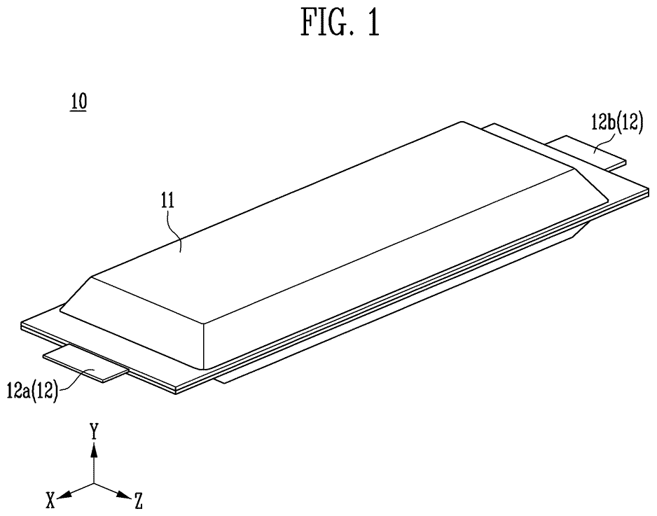

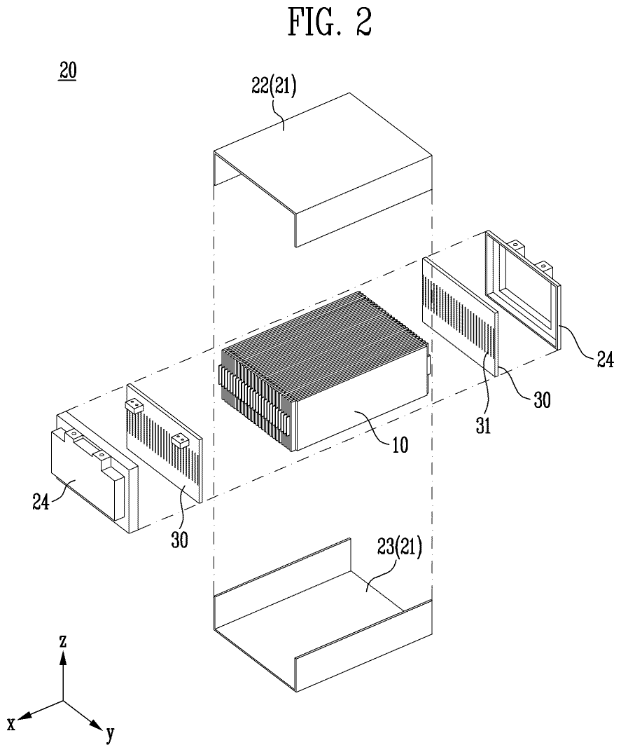

FIG. 1 shows a battery cell 10 according to one embodiment of the present disclosure, and FIG. 2 shows a battery assembly 20 according to one embodiment of the present disclosure.

The battery cell 10 described herein refers to a secondary battery which can be used repeatedly by charging and discharging electrical energy. In one example, the battery cell 10 may refer to a lithium secondary battery or a lithium-ion battery. However, the present disclosure is not limited thereto. In another example, the battery cell 10 may refer to a solid-state battery.

The battery cell 10 may be classified into as a pouch secondary battery, a prismatic secondary battery, or a cylindrical secondary battery based on the shape thereof. For ease of explanation, a prismatic secondary cell is shown herein as an example, but the present disclosure is not limited thereto.

The battery assembly described herein may refer to a battery module or a battery pack. The battery module may refer to a group of one or more battery cells 10 received in a case to be protected from external shock, heat, vibration, etc. for high power and high capacity characteristics. The battery pack may refer to a group of one or more battery cells or battery modules.

Referring to FIG. 1, the battery cell 10 includes a lead tab portion 12 which is electrically connected to the outside and protrudes outwardly. The battery cell 10 may further include a body portion 11.

The body portion 11 may produce or store electrical energy. The body portion 11 may include an electrode assembly (not shown) which includes an anode, a cathode, and a separator for producing and storing electrical energy. The body portion 11 may further include an electrolyte in contact with the electrode assembly. The electrolyte may be an electrolyte liquid provided as a liquid.

The body portion 11 may further include an exterior material. The exterior material may have an electrode assembly and an electrolyte liquid therein. The exterior material may be a highly rigid material to protect the electrode assembly and the electrolyte liquid received therein from impact.

The lead tab portion 12 may electrically connect the body portion 11 to the outside. The lead tab portion 12 may include a plurality of lead tab portions. The lead tab portion 12 may include an anode tab 12a connected to an anode and a cathode tab 12b connected to a cathode. More specifically, the lead tab portion 12 may include the anode tab 12a connected to at least one anode plate, and the cathode tab 12b connected to at least one cathode plate.

The lead tab portion 12 may protrude in a direction away from both sides of the body portion 11. Referring to FIG. 1, the anode and cathode tabs may protrude in opposite directions. However, the present disclosure is not limited thereto. The anode tab and the cathode tab may be provided next to each other on one surface of the body portion 11.

As used herein, the protruding direction of the lead tab portion 12 may refer to a direction parallel to the X-axis direction. Further, the direction in which the lead tab portion 12 extends may refer to a direction parallel to the Z-axis direction. Further, the lead tab portion 12 may refer to an electrode lead tab.

More specifically, FIG. 2 is an exploded view of the battery assembly 20. The battery assembly 20 may include a plurality of battery cells 10. The plurality of battery cells 10 may be stacked in a first direction. For example, the plurality of battery cells 10 may be stacked in a y-axis direction.

An adhesive member (not shown) may be provided between the plurality of battery cells 10. The plurality of battery cells 10 may be reliably connected by the adhesive member. For example, the adhesive member may be a tape. Further, a battery compression pad (not shown) may be provided between the plurality of battery cells 10. The compression pad may relieve the surface pressure between the battery cells 10 to prevent damage to the battery cells 10. To this end, the compression pad may include a shock absorbing material or an elastic material.

In this specification, the direction in which the plurality of battery cells 10 are stacked may refer to a direction next to the Y-axis direction.

The battery assembly 20 may include a receiving case 21 forming a receiving space in which the plurality of battery cells 10 are housed. In other words, the plurality of battery cells 10 may be located in the receiving space.

The receiving case 21 may include a lower cover 23 which supports the plurality of battery cells 10 and an upper cover 22 which is engaged with the lower cover 23 and covers the receiving space. Referring to FIG. 2, the lower cover 23 and the upper cover 22 may be coupled together to accommodate the plurality of battery cells 10 therein.

More specifically, the plurality of battery cells 10 may be inserted through an opening in the lower cover 23. After the plurality of battery cells 10 are positioned on the lower cover 23, the upper cover 22 may be coupled with the lower cover 23 to cover the plurality of battery cells 10.

The battery assembly 20 may further include an end cover 24. The end cover 24 may be coupled to the receiving case 21 to cover the receiving space. The end cover 24 may protect the battery cells 10 located in the receiving space. To this end, the end cover 24 may be coupled to the receiving case 21. For example, the end cover 24 and the receiving case 21 may be connected by welding or bolting.

The battery assembly 20 may further include a busbar 30. The busbar 30 may electrically connect at least some of the plurality of battery cells 10. The busbar 30 may be positioned to face the battery cells 10 in the protruding direction of the lead tab portions 12. Referring to FIG. 2, the busbar 30 may be positioned on either side of the battery cells 10.

The lead tab portion 12 and the busbar 30 may be electrically connected to each other. For simplicity and reliability, the lead tab portion 12 may be inserted into an insertion hole 31 provided in the busbar 30. The insertion hole 31 may be formed through one surface of the busbar 30. As the busbar 30 approaches the plurality of battery cells 10, one end of the lead tab portion 12 may be inserted into the insertion hole 31.

The busbar 30 may include an insertion slit which is provided in the form of a slit rather than a hole. The lead tab portion 12 may be inserted through an opening in the insertion slit. The present disclosure is not limited thereto. The busbar 30 may have a variety of shapes into which the lead tab portion 12 is inserted.

When the lead tab portion 12 is inserted into the busbar 30, a portion of the lead tab portion 12 may protrude outwardly. When the lead tab portion 12 and he busbar 30 are welded, the weld performance may vary depending on the protruding length of the lead tab portion 12. For example, when the lead tab portion 12 is short, a weldable area with the busbar 30 is reduced, which may result in poorer weld quality.

The disclosure may include the welding wire 210 which is at least partially molten to weld the lead tab portion 12 and the busbar 30. More specifically, the present disclosure may provide the welding wire 210 which allows a welded joint to be reliably formed between the lead tab portion 12 and the busbar 30.

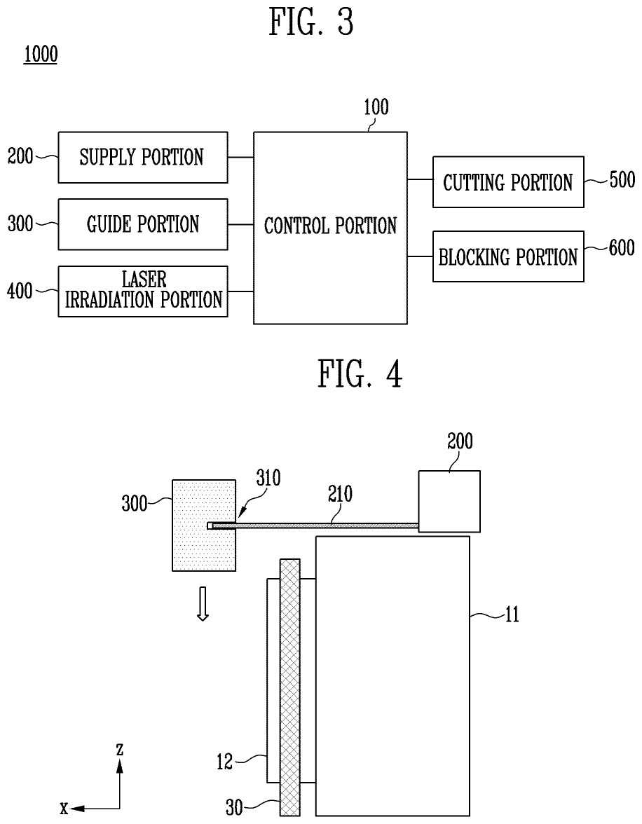

FIG. 3 is an example block diagram related to control of a battery manufacturing apparatus according to one embodiment of the present disclosure.

Referring to FIG. 3, the battery manufacturing apparatus of the present disclosure includes a supply portion 200, a guiding portion 300, and a laser irradiation portion 400. The supply portion 200 supplies the welding wire 210 which is at least partially molten to weld the lead tab portion 12 and the busbar 30.

The guiding portion 300 may contact the welding wire 210 which is discharged from the supply portion 200 to move the welding wire 210 in the direction in which the lead tab portion 12 extends. The laser irradiation portion 400 irradiates the lead tab portion 12, the busbar 30, or the welding wire 210 with a laser.

The battery manufacturing apparatus of the present disclosure further includes a control portion 100. The control portion 100 may control the supply portion 200, the guiding portion 300, and the laser irradiation portion 400. The present disclosure may further include a cutting portion 500 or a blocking portion 600 to be described below. The control portion 100 may control the cutting portion 500 or the blocking portion 600. In the following, each configuration will be described in detail with reference to the drawings.

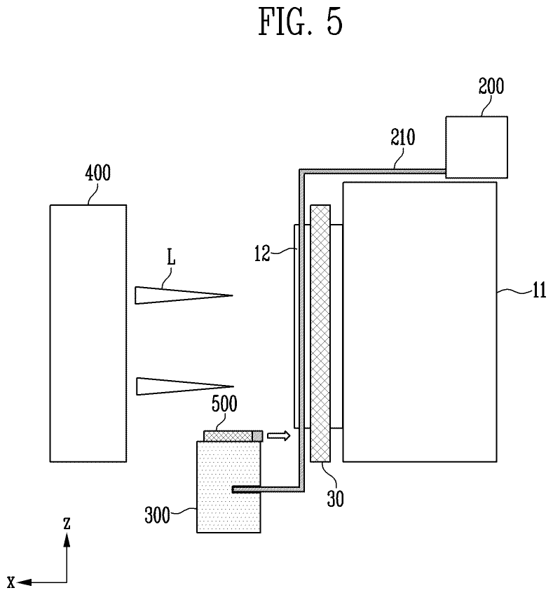

FIGS. 4 to 7 schematically show a welding process of a battery manufacturing apparatus according to one embodiment of the present disclosure.

Referring to FIG. 4, the supply portion 200 may supply the welding wire 210 to the lead tab portion 12. The welding wire 210 may include a filler metal. The welding wire 210 may be used to regulate heat capacity during welding. The welding wire 210 may be used to weld two metals which do not react with each other, or may be added to materials which react with each other for welding.

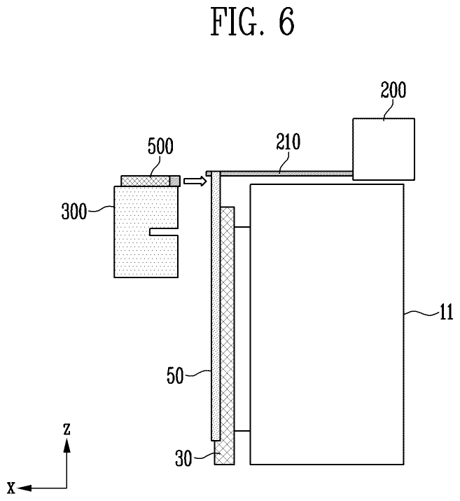

At least a portion of the welding wire 210 may be melted. The laser irradiated during welding may melt a portion of the welding wire 210, thereby allowing the busbar 30 and the lead tab portion 12 to be connected to each other. In addition, a weld bead 50 in FIG. 6 may be formed between the busbar 30 and the lead tab portion 12 after the welding is finished.

The guiding portion 300 may contact the welding wire 210 discharged from the supply portion 200 to move the welding wire in the direction in which the lead tab portion 12 extends. The guiding portion 300 may contact the welding wire 210. One end of the welding wire 210 discharged from the supply portion 200 may contact the guiding portion 300. To this end, the guiding portion 300 may include a fixing portion 310 formed by depressing one surface. The fixing portion 310 may be formed to face the direction in which the welding wire 210 is supplied.

One end of the welding wire 210 may be positioned on the fixing portion 310. The fixing portion 310 may pressurize the welding wire 210 to secure the welding wire 210. The fixing portion 310 may be removable from the welding wire 210.

That is, when the welding wire 210 is discharged from the supply portion 200, the fixing portion 310 may pressurize and hold the welding wire 210. With the welding wire 210 secured to the fixing portion 310, the guiding portion 300 may be moved. When the welding is completed, the welding wire 210 may be disconnected from the fixing portion 310.

The fixing portion 310 may be movable in the direction in which the lead tab portion 12 extends. The movement of the fixing portion 310 allows the welding wire 210 to cover the lead tab portion 12.

The distance at which the fixing portion 310 is moved may vary depending on the length of the lead tab portion 12 or the area to be welded. More specifically, the fixing portion 310 may move so that the welding wire 210 may be longer than the lead tab portion 12.

Referring to FIGS. 4 and 5, with the lead tab portion 12 secured to the fixing portion 310, the fixing portion 310 may move downwardly. The welding wire 210 may be positioned to overlap with at least one of the busbar 30 and the lead tab portion 12. Alternatively, the welding wire 210 may be positioned between the busbar 30 and the lead tab portion 12. As the welding wire 210 is positioned between the busbar 30 and the lead tab portion 12, the welding wire 210 may be further applied to weld the lead tab portion 12 even when the lead tab portion 12 has a short protrusion length.

After the welding wire 210 is positioned between the busbar 30 and the lead tab portion 12, the laser irradiation portion 400 may irradiate the welding wire 210 with a laser to weld the welding wire 210. The laser may be irradiated onto the welding wire 210 and onto the busbar 30 and lead tab portion 12 adjacent to the welding wire 210.

In an embodiment, the laser may be irradiated in an extension direction of the lead tab portion 12. In this manner, welding proceeds sequentially from one end to the other end to increase welding stability and performance.

Referring to FIG. 6, after the laser is irradiated, the weld bead 50 may be formed. The weld bead 50 may be formed in the region where the welding wire 210 is located. In other words, the weld bead 50 may extend in the longitudinal direction of the lead tab portion 12.

The cutting portion 500 may cut the welding wire 210 moving in the direction in which the lead tab portion 12 extends. The cutting portion 500 may be provided as a knife. The present disclosure is not limited thereto. The cutting portion 500 may be configured to cut the welding wire 210. The cutting portion 500 may cut one end of the welding wire 210 which is connected to the fixing portion 310.

The cutting portion 500 may be located on the guiding portion 300. The cutting portion 500 may be located on the guiding portion 300 and operate independently of the guiding portion 300. The cutting portion 500 may move in parallel with the protruding direction of the lead tab portion 12 to cut the welding wire 210.

Referring to FIG. 6, the cutting portion 500 may cut a portion of the welding wire 210 which has been completely welded. More specifically, the cutting portion 500 may cut a region of the welding wire 210 which is located at the upper side in the direction in which the lead tab portion 12 extends. As a result, the weld bead 50 may be cut off from the welding wire 210 supplied by the supply portion 200.

The cutting portion 500 may cut the welding wire 210 several times. The welding wire 210 may be cut at different heights in the direction in which the lead tab portion 12 extends. By gently cutting one end of the weld bead 50, injury to the user or damage to the component may be prevented.

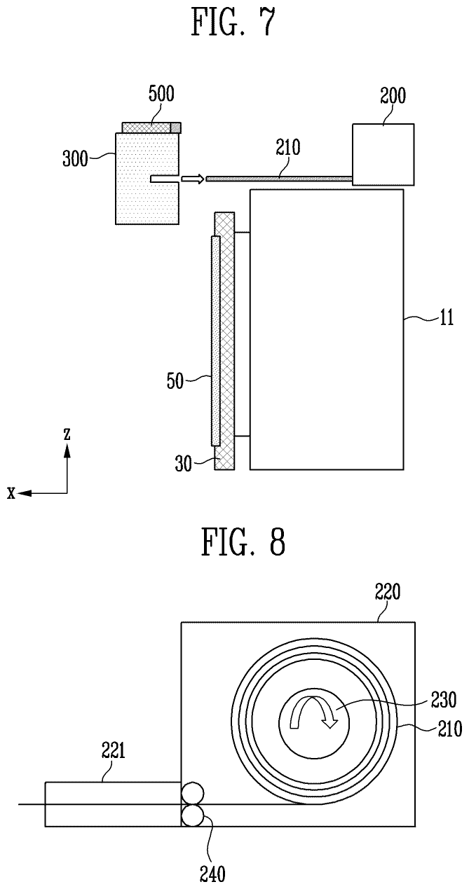

Referring to FIG. 7, after the welding wire 210 is cut, the fixing portion 310 may fix the welding wire 210 which is supplied again from the supply portion 200, and the processes described above may be repeated.

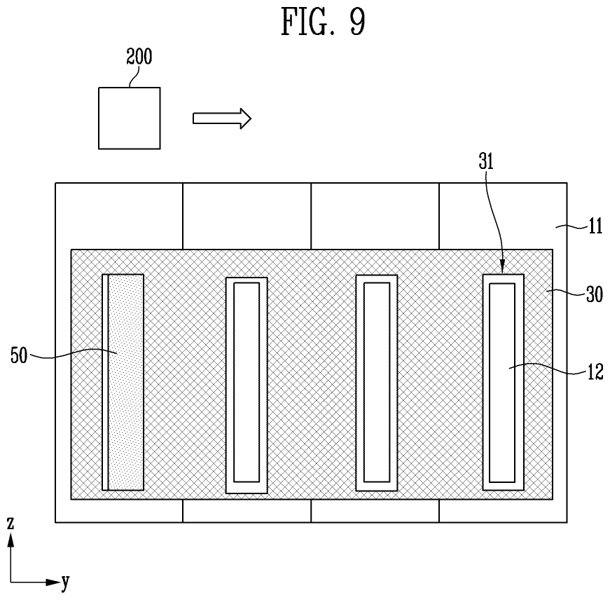

FIGS. 8 and 9 show the supply portion 200 according to one embodiment of the present disclosure.

More specifically, FIG. 8 shows the components of the supply portion 200 in more detail. The supply portion 200 may receive and discharge the welding wire 210 to the outside. The supply portion 200 may include a winder 230 and rollers 240. The welding wire 210 is wound around the outer side of the winder 230, and the rollers 240 unidirectionally feed the welding wire 210 unwound from the winder 230 through rotation with the welding wire 210 interposed between the rollers 240.

The winder 230 and the rollers 240 may be provided in the housing 220. The welding wire 210 which is unwound from the winder 230 may be stably fed out of the housing 220 by the rollers 240 provided in a discharging portion 221.

The winder 230 may be rotatably provided. Referring to FIG. 8, the winder 230 may rotate clockwise about an axis. However, the winder 230 may also rotate counterclockwise, or the direction of the axis may vary.

The welding wire 210 may be wound and stored on the winder 230. The winder 230 may rotate to eject the welding wire 210. The welding wire 210 may be positioned between the rollers 240. The rollers 240 may guide the wire 210 being unwound by rotation into the discharging portion 221.

The supply portion 200 may be located above the plurality of battery cells 10. The discharging portion 221 may extend from the housing 220 toward the direction in which the lead tab portion 12 is located. Since it is difficult to control the welding wire 210 when the length of the welding wire 210 increases, the discharging portion 221 may be elongated to guide the welding wire 210 to a desired location.

The discharging portion 221 may preferably extend to the location of the lead tab portion 12. The welding wire 210 fed from the discharging portion 221 may be secured by the fixing portion 310 to move the welding wire 210.

The battery manufacturing apparatus of the present disclosure may supply the welding wire 210 to each of the lead tab portions 12 provided on the plurality of battery cells 10. Thus, plurality of supply portions 200 may be provided, or the supply portion 200 may be moved to supply a wire to each of the lead tab portions 12.

The supply portion 200 may move in the direction in which the plurality of battery cells 10 are stacked. Once welding of one lead tab of the plurality of battery cells is completed, the supply portion may be moved to weld another lead tab.

Referring to FIG. 9, after welding of the lead tab portion 12 on the left side has been completed, the supply portion 200 may be moved to weld the adjacent lead tab portion 12. In this manner, the volume of the manufacturing apparatus of the present disclosure is reduce and the supply of welding wire 210 is easily supplied.

The supply portion 200 may be arranged on a transfer rail (not shown) and transferred, or the supply portion 200 may be mounted on a transfer device (not shown) and moved, or transferred by a robot.

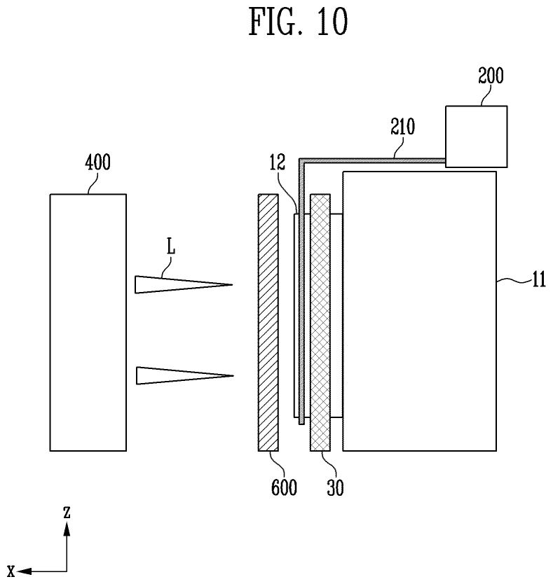

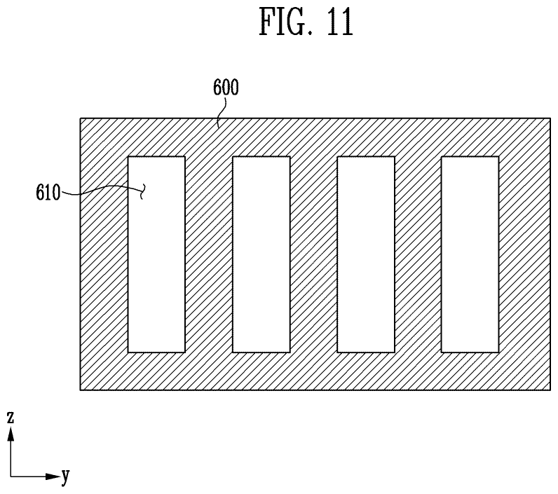

FIGS. 10 and 11 show the blocking portion 600 according to one embodiment of the present disclosure.

The manufacturing device of the present disclosure may further include the blocking portion 600. The blocking portion 600 may be positioned between the laser irradiation portion 400 and the plurality of battery cells 10 to cover at least some of the plurality of battery cells 10. The blocking portion 600 may protect the plurality of battery cells 10 from the laser. In other words, the blocking portion 600 may prevent laser irradiation to areas other than the welded area during laser welding.

The blocking portion 600 may include a material which absorbs or reflects a laser beam of a particular wavelength.

Referring to FIG. 10, in the direction in which the lead tab portion 12 protrudes, the blocking portion 600 may be arranged to overlap the plurality of battery cells 10. Further, an opening is formed through a region of the blocking portion 600 corresponding to the lead tab and allows the laser to pass therethrough.

Also, referring to FIG. 11, the blocking portion 600 may include through-holes 610 which are formed through regions corresponding to the lead tab portions 12. The through-hole 610 allows the laser to pass therethrough. In other words, the blocking portion 600 may open an area to be welded to allow laser to therethrough and block other areas from the laser.

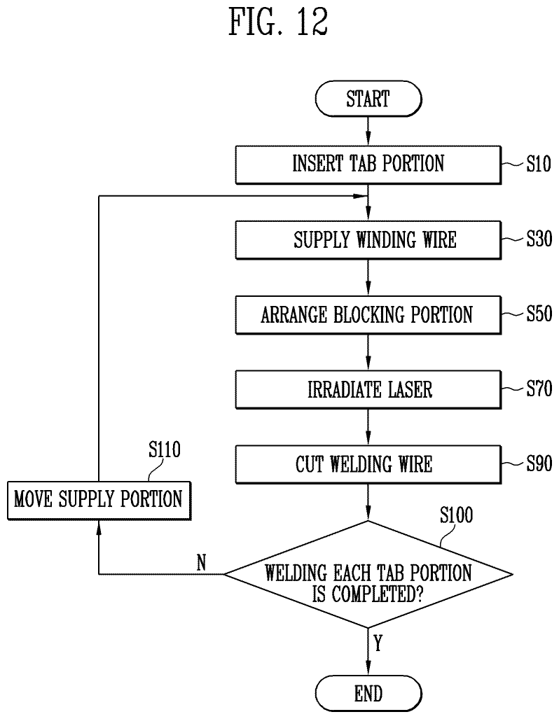

The lead tab portion 12, the busbar 30, and the welding wire 210 which are opened by the through-hole 610 may be welded by the laser, but other areas may not be irradiated by the laser. Hereinafter, the battery manufacturing method of the present disclosure will be described in detail with reference to FIG. 12.

FIG. 12 is a flowchart illustrating a battery manufacturing method according to one embodiment of the present disclosure.

Referring to FIG. 12, the battery manufacturing method of the present disclosure includes inserting the lead tab portion 12 into the busbar 30 at step S10, supplying the welding wire 210 toward the lead tab portion 12 from the supply portion 200 supplying the welding wire 210 which is at least partially molten and welds the lead tab portion 12 and the busbar 30 at step S30, and irradiating the lead tab portion 12, the busbar 30, or the welding wire 210 with a laser at step S70.

First, the lead tab portion 12 may be inserted into the busbar 30. More specifically, the lead tab portion 12 may be inserted into the insertion hole 31 provided in the busbar 30. However, the lead tab portion 12 may also be inserted into a slit which is open on one side of the busbar 30, rather than into the insertion hole 31 in FIG. 2.

The plurality of battery cells 10 may be secured on a support member (not shown). The busbar 30 may be moved toward the lead tab portions 12 of the plurality of fixed battery cells 10 and inserted into the insertion holes 31. The busbar 30 may be moved by a separate device (not shown). For example, the busbar 30 may be held and moved by a robot.

According to the manufacturing method of the present disclosure, the welding wire 210 may be supplied from the supply portion 200 towards the lead tab portion 12 after the lead tab portion 12 is inserted into the busbar 30. At step S30 of supplying the welding wire 210, the welding wire 210 may be moved in the direction in which the lead tab portion 12 extends. In other words, the welding wire 210 is fed in the direction in which the lead tab portion 12 extends so that welding may proceed stably and quickly.

After the welding wire 210 is supplied, laser irradiation may be performed at step S70. In other words, once the welding wire 210 is supplied and positioned adjacent to the lead tab portion 12 and the busbar 30, welding may proceed by irradiating the welding wire 210 with a laser to melt the welding wire 210.

Further, according to the manufacturing method of the present disclosure, the laser may be irradiated in the direction in which the lead tab portion 12 extends during laser irradiation at step S70. Eventually, after the welding wire 210 is moved in the direction in which the lead tab portion 12 extends, the laser may be irradiated onto the welding wire 210.

Step S30 in which the welding wire 210 is fed may be performed simultaneously with step S70 in which the laser is irradiated. In other words, the laser may be irradiated as the welding wire 210 is fed.

The manufacturing method of the present disclosure may further include arranging the blocking portion 600 at step S50. According to the manufacturing method of the present disclosure, the blocking portion 600 covering at least a portion of the plurality of battery cells 10 may be arranged on one side of the plurality of battery cells 10 in the protruding direction of the lead tab portion 12.

Step S50 of arranging the blocking portion 600 may be performed between step S10 of inserting the lead tab portion 12 into the busbar 30 and step S70 of irradiating the laser. Further, step S50 of arranging the blocking portion 600 may preferably be performed after step S30 in which the welding wire 210 is fed. When the guiding portion 300 moves the welding wire 210, the blocking portion 600 may restrict the movement radius of the guiding portion 300.

The manufacturing method of the present disclosure may further include cutting the welding wire 210 at step S90. The manufacturing method of the present disclosure may further include cutting the welding wire 210 moving in the direction in which the lead tab portion 12 extends at step S90. The cutting portion 500 may cut the welding wire 210 connected to the guiding portion 300 after the laser is irradiated onto the welding wire 210. Further, the cutting portion 500 may cut a region of the welding wire 210 which is connected from the top in the direction in which the lead tab portion 12 extends.

In other embodiments, step S90 of cutting the welding wire 210 may be performed before and after step S70 of irradiating the laser. In other words, after the welding wire 210 is fed in the direction in which the lead tab portion 12 extends, step S90 of cutting the welding wire 210 secured to the guiding portion 300 may be performed, and the laser may then be irradiated. After the laser is irradiated, step S90 of cutting the welding wire 210 connected to the supply portion 200 may be performed.

The manufacturing method of the present disclosure may further include moving the supply portion 200 in a direction where the plurality of battery cells 10 are stacked at step S110. After the lead tab portions 12 of any one of the plurality of battery cells 10 is completely welded (S100), the supply portion 200 may move to weld another lead tab portion 12.

The control unit 100 may determine whether each lead tab portion 12 of the plurality of battery cells 10 has been welded. That is, when the control unit 100 determines that welding each lead tab portion 12 is not completed, the manufacturing method of the present disclosure may include moving the supply portion 200 so as to continue welding. On the other hand, when the control unit 100 determines that each lead tab portion 12 is completely welded, the manufacturing method of the present disclosure may be terminated.

According to one embodiment of the present disclosure, a battery cell and a busbar may be welded quickly and reliably.

In addition, welding may be performed reliably regardless of a length of a lead tab portion.

The present disclosure may be modified and implemented in various forms, and its scope is not limited to the above-described embodiments. The content described above is merely an example of applying the principles of the present disclosure, and other features may be further included without departing from the scope of embodiments according to the present disclosure.

What is claimed is:

1. A battery manufacturing apparatus for manufacturing a battery assembly including a plurality of battery cells, each having a lead tab portion electrically connected to an outside and protruding outwardly, and a busbar electrically connecting one or more battery cells among the plurality of battery cells, the battery manufacturing apparatus comprising:
a welding wire, at least a portion of which is melted to weld the lead tab portion and the busbar;
a supply portion supplying the welding wire to the lead tab portion;
a guiding portion contacting the welding wire discharged from the supply portion and moving the welding wire in a direction in which the lead tab portion extends; and
a laser irradiation portion irradiating the lead tab portion, the busbar, or the welding wire with a laser.

2. The battery manufacturing apparatus of claim 1, wherein the supply portion includes:
a winder around which the welding wire is wound on an outer side thereof; and
a roller unidirectionally transferring the welding wire unwound from the winder by rotation with the welding wire interposed therebetween.

3. The battery manufacturing apparatus of claim 2, wherein the winder is rotatably provided.

4. The battery manufacturing apparatus of claim 1, wherein the guiding portion further includes a fixing portion formed by recessing one surface thereof.

5. The battery manufacturing apparatus of claim 4, wherein the fixing portion is removable from the welding wire.

6. The battery manufacturing apparatus of claim 4, wherein the fixing portion is movable in the direction in which the lead tab portion extends.

7. The battery manufacturing apparatus of claim 1, further comprising a cutting portion cutting the welding wire moved in the direction in which the lead tab portion extends.

8. The battery manufacturing apparatus of claim 7, wherein the cutting portion is located on the guiding portion.

9. The battery manufacturing apparatus of claim 7, wherein the cutting portion is a knife.

10. The battery manufacturing apparatus of claim 1, further comprising a blocking portion positioned between the laser irradiation portion and the plurality of battery cells and covering one or more battery cells among the plurality of battery cells.

11. The battery manufacturing apparatus of claim 10, wherein the blocking portion is formed by penetrating a region corresponding to the lead tab portion.

12. The battery manufacturing apparatus of claim 1, wherein the supply portion is movable in a direction in which the plurality of battery cells are stacked.

13. A battery manufacturing method of manufacturing a battery assembly including a plurality of battery cells, each having a lead tab portion electrically connected to an outside and protruding from one side thereof, and a busbar electrically connecting one or more battery cells among the plurality of battery cells, the battery manufacturing method comprising:
inserting the lead tab portion into the busbar;
supplying the welding wire toward the lead tab portion from the supply portion supplying the welding wire welding the lead tap portion and the busbar by melting at least a portion of the welding wire; and
irradiating the lead tab portion, the busbar, or the welding wire with a laser.

14. The battery manufacturing method of claim 13, wherein in the supplying of the welding wire, the welding wire moves in a direction in which the lead tab portion extends.

15. The battery manufacturing method of claim 13, further comprising moving the supply portion in a direction in which the plurality of battery cells are stacked.

16. The battery manufacturing method of claim 13, further comprising arranging a blocking portion covering one or more battery cells among the plurality of battery cells on one side of the plurality of battery cells in a protruding direction of the lead tab portion.

17. The battery manufacturing method of claim 13, wherein the irradiating the laser includes irradiating the laser in a direction in which the lead tab portion extends.

18. The battery manufacturing method of claim 13, further comprising cutting the welding wire moved in a direction in which the lead tab portion extends.
